(19) United States
(12) Patent Application Publication
(10) Pub. No.: US 2017/0036684 A1
(43) Pub. Date: Feb. 9, 2017

(54) CABIN MONITORING SYSTEM FOR TRAIN LOCOMOTIVE

(71) Applicant: Progress Rail Services Corporation, Albertville, AL (US)

(72) Inventors: Stephen Harold HUMPHREY, Pleasant Hill, MO (US); Marc David MILLER, Lee's Summit, MO (US)

(73) Assignee: PROGRESS RAIL SERVICES CORPORATION, Albertville, AL (US)

(21) Appl. No.: 14/820,309

(22) Filed: Aug. 6, 2015

(51) Int. Cl. B61L 15/00; H04N 5/33; H04N 7/18

(52) U.S. Cl. CPC B61L 15/0063; B61L 15/0081; H04N 7/188; H04N 5/33

(57) ABSTRACT

A cabin monitoring system is disclosed for use with a machine having an operator cabin. The cabin monitoring system may have a scanner oriented inward to capture images inside the operator cabin, and a controller in communication with the scanner. The controller may be configured to determine a change in conditions inside the operator cabin, and to selectively affect operation of the scanner based on the change in conditions.

### TECHNICAL FIELD

The present disclosure relates generally to a monitoring system and, more particularly, to a system for monitoring the cabin of a train locomotive.

### BACKGROUND

Locomotive monitoring systems are known in the art and used to record images of the locomotive's surroundings. These images can then be used to determine conditions that existed during or that led up to an event (e.g., a derailment, a collision, a theft, a vandalism, or another mishap). Some known monitoring system record images continuously, while other systems record images only in response to specific input indicative of an event.

An exemplary system is disclosed in U.S. Pat. No. 8,913,131 that issued to Chung et al. on Dec. 16, 2014 (“the '131 patent”). The system of the '131 includes one or more cameras directed out the front of the locomotive, out the rear of the locomotive, and/or to either side of the locomotive to capture outward-bound images of the vehicle's surroundings. The system also includes a processor configured to control recording of video data by the camera(s) based on operating conditions of the vehicle. For example, the processor adjusts a frame rate and/or a resolution of the camera(s) based on a time of day, weather, environmental lighting conditions, travel speed, track topology, or GPS location. By adjusting camera control based on vehicle operating conditions, storage space filled with images from the camera(s) is used efficiently while still producing images of acceptable quality.

Although the system of the '131 patent may be helpful in diagnosing some events, the system may be limited. In particular, activities occurring inside the locomotive can sometimes attribute to particular events, and the system of the '131 patent may not be able to record these activities. In addition, some events could actually occur onboard the locomotive and may go unnoticed by the system of the '131 patent.

The present disclosure is directed at overcoming one or more of the shortcomings set forth above and/or other problems of the prior art.

### SUMMARY

In one aspect, the present disclosure is directed to a cabin monitoring system for a machine having an operator cabin. The cabin monitoring system may include a scanner oriented inward to capture images inside the operator cabin, and a controller in communication with the scanner. The controller may be configured to determine a change in conditions inside the operator cabin, and to selectively affect operation of the scanner based on the change in conditions.

In another aspect, the present disclosure is directed to a locomotive. The locomotive may include a car body, an engine, at least one truck configured to support the car body and the engine, a plurality of wheels connected to the at least one truck, and an operator cabin connected to the car body and supported by the at least one truck. The operator cabin may have at least one operator input device located therein that is movable to create control signals associated with operation of the locomotive. The locomotive may further include a camera oriented inward to capture images inside the operator cabin, a light source located inside the operator cabin, and a controller in communication with the at least one input device, the camera, and the light source. The controller being configured to determine a change in conditions inside the operator cabin based on the control signals, and to selectively affect at least one of a frame rate of the camera, a resolution of the camera, or an intensity of the light source based on the change in conditions.

In yet another aspect, the present disclosure is directed to a method of monitoring an operator cabin of a machine. The method may include capturing images inside the operator cabin with a scanner, and determining a change in conditions inside the operator cabin. The method may also include selectively affecting operation of the scanner based on the change in conditions,

### BRIEF DESCRIPTION OF THE DRAWING

FIG. 1 is an isometric illustration of an exemplary disclosed locomotive;

FIG. 2 is an isometric illustration of an exemplary disclosed cabin that may form a portion of the locomotive of FIG. 1; and

FIG. 3 is a diagrammatic illustration of an exemplary disclosed monitoring system that may be used in conjunction with the locomotive and cabin of FIGS. 1 and 2.

### DETAILED DESCRIPTION

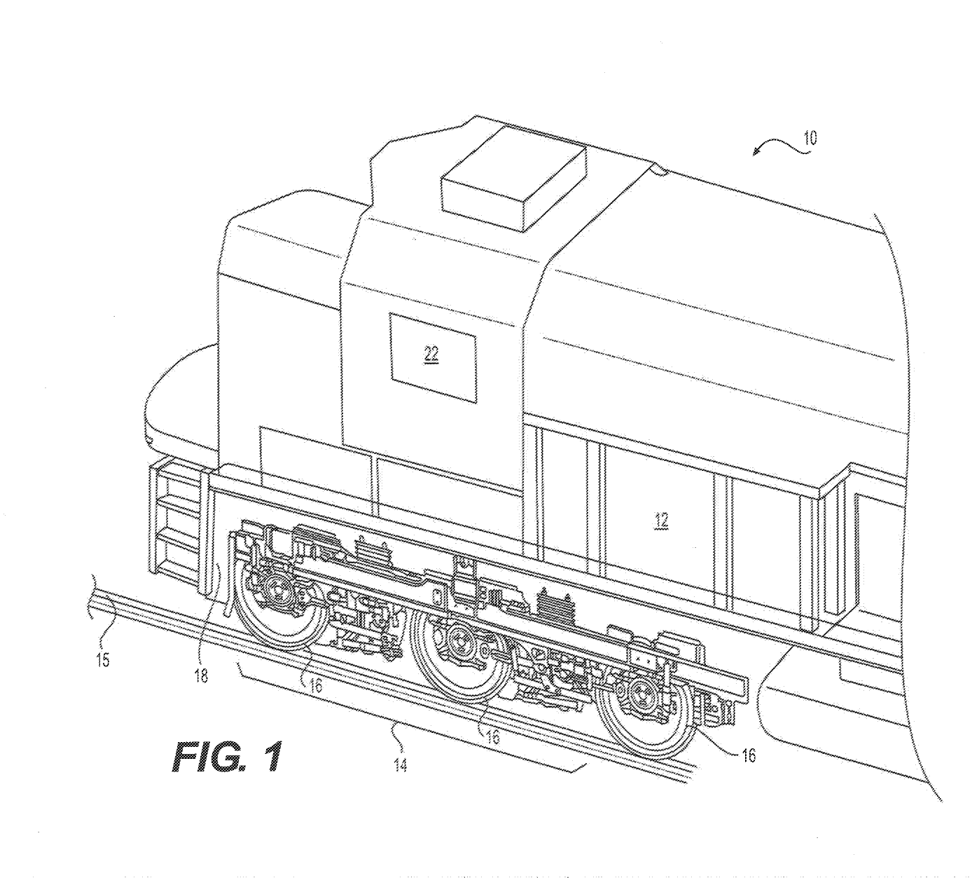

FIG. 1 illustrates an exemplary mobile machine 10. In the disclosed example, machine 10 is a locomotive. However, it is contemplated that machine 10 may embody another type of machine, if desired. For example, machine 10 may embody an on or off-highway haul truck, a construction machine, a vocational machine, or another type of machine. Alternatively, machine 10 could be a stationary machine, such as a genset, a pump, or a drill that requires continuous attention from an operator. Other types of machines may also be possible.

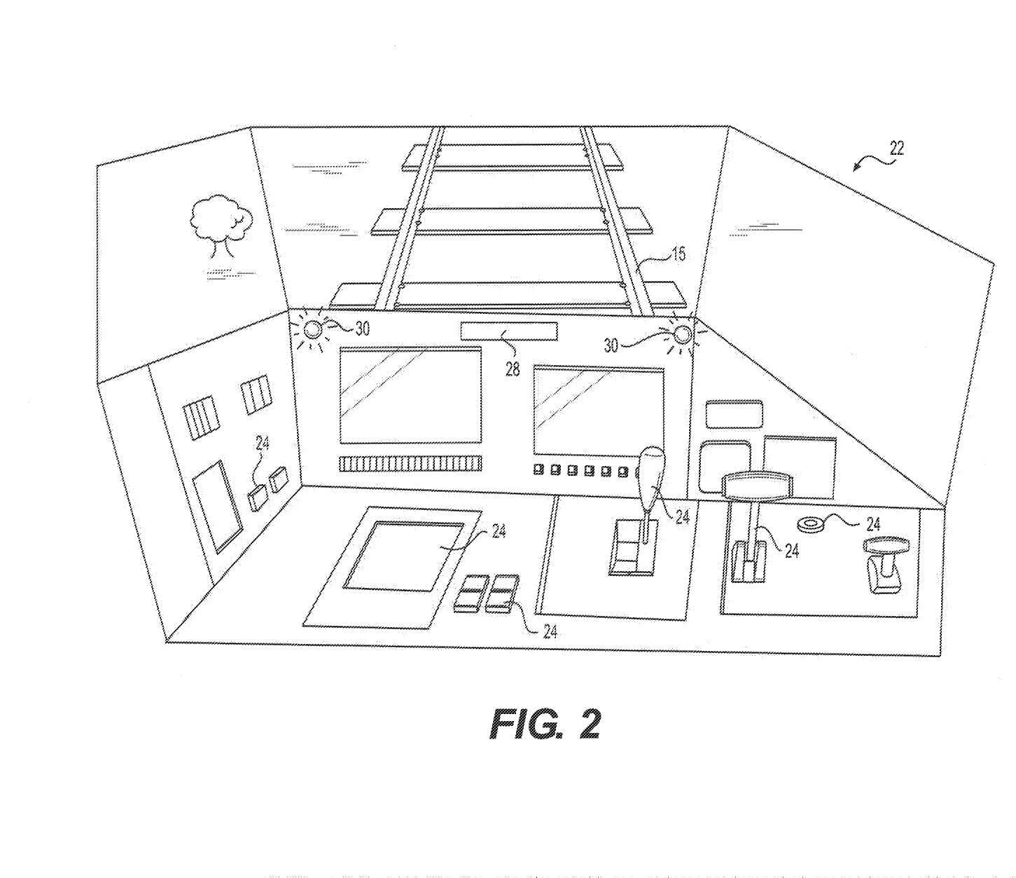

As a locomotive, machine 10 may include a car body 12 supported at opposing ends by a plurality of trucks 14 (only one truck 14 shown). Each truck 14 may be configured to engage a track 15 (shown only in FIG. 2) via a plurality of wheels 16, and to support a frame 18 of car body 12. Any number of engines (not shown) may be mounted to frame 18 within car body 12 and drivingly connected to produce power that propels wheels 16. Control over propulsion (and other train functions) may be provided by way of a cabin 22 that is supported by frame 18 and connected to car body 12.

The interior of an exemplary cabin 22 is shown in FIG. 2. As can be seen in this figure, cabin 22 may house a plurality of input devices 24. Input devices 24 may be used by an operator to control machine 10 and embody any type of device known in the art. For example, input devices 24 may include, among other things, a throttle configured to control fueling of the engines, a brake lever configured to control braking of machine 10, interior and/or exterior light switches, windshield. wiper controls, a horn activation button, door activation and/or lock controls, climate controls, etc. Input devices 24 may be embodied as levers, pedals, wheels, knobs, push-pull devices, touch screen displays, etc.

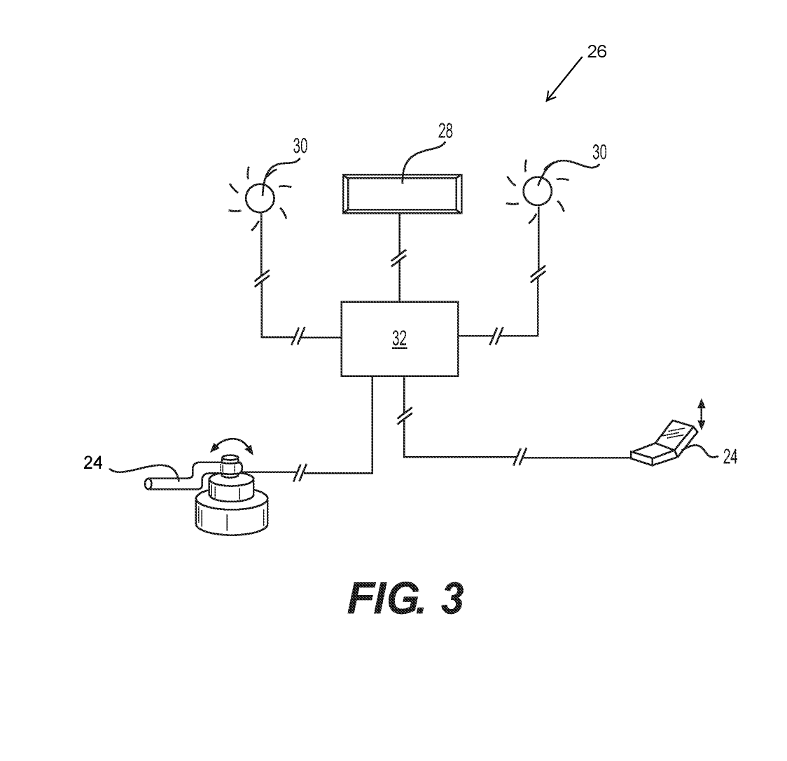

In the disclosed embodiment, movements and other activities of a machine operator may be tracked from inside of cabin 22. These movements and/or activities may include the use of input devices 24. For example, in addition to generating control signals used to control machine operations, one or more of the signals generated by input devices 24 may also be monitored and used by a monitoring system 26 (“system”—shown in FIG. 3) as a way to determine an activity level, activity type, and/or status of the operator or machine cabin 22. In particular, based on a frequency and/or timing of input device use, system 26 may be able to determine if the operator is inside cabin 22, if the operator is alert, what interior and/or exterior conditions exist, etc.

In addition to using the frequency and/or timing of input device use as a way to determine activity and/or status of the machine operator and/or cabin 22, system 26 may also use dedicated hardware for this same purpose. For example, system 26 may include a scanner 28 alone or together with one or more light sources 30. In the disclosed example, scanner 28 is an IR scanner (e.g., camera) and multiple light sources 30 produce IR light that is visible only to scanner 28 for use during low-light conditions. Other types of scanners and/or light sources may alternatively be utilized for this purpose, if desired. Scanner 28 and light sources 30 may be located within cabin 22, for example within a central control panel facing the machine operator.

As shown in FIG. 3, system 26 may include a controller 32 that is in communication with. input devices 24, scanner 28, and light sources 30. Controller 32 may be configured to receive signals generated by these components, to determine the activity or status of the operator and cabin 22 based on the signals, and to selectively adjust operation of scanner 28 and/or light sources 30 based on the signals. In the disclosed example, the settings of scanner 28 and/or light sources 30 may include an activation level (e.g., on or off), a setting (e.g., a frame speed, a zoom level, still or video mode, real time or time lapsed, high- or low-resolution, high- or low-intensity, etc.), an angle, a location etc. The operation of scanner 28 and/or light sources 30 may be selectively adjusted to improve a quality of images produced by scanner 28 and/or to reduce an amount of storage space consumed by the images from scanner 28.

Controller 32 may embody a single microprocessor or multiple microprocessors that include a means for controlling operations of machine 10 (e.g., of system 26) in response to received signals. Numerous commercially available microprocessors can be configured to perform the functions of controller 32. It should be appreciated that controller 32 could readily embody a general machine microprocessor capable of controlling numerous machine functions. Controller 32 may include a memory, a secondary storage device, a processor, a timer, and any other components for running an application. Various other circuits may be associated with controller 32 such as power supply supply circuitry, signal conditioning circuitry, solenoid driver circuitry, and other types of circuitry.

### INDUSTRIAL APPLICABILITY

The disclosed monitoring system may be applicable to any machine where cabin monitoring is important. The disclosed monitoring system may allow for tracking of cabin activities in an efficient manner that produces high-quality data when necessary. Operation of monitoring system 26 will now be described in detail.

During operation of machine 10, system 26 may be used to capture still images and/or video of the inside of cabin 22. It is contemplated that system 26 may be continuously active or selectively active based on a variety of different conditions. For example, system 26 may be active any time that machine 10 is turned on. Alternatively, system 26 may be manually activated by the operator and/or activated based on one or more monitored inputs (e.g., movement of an input device 24, use of a cabin door or door lock, time of day and/or date, location, etc.). Once activated, controller 32 may cause scanner 28 to generate image data that is then stored in memory and/or transmitted of board machine 10 (e.g., to a back office for analysis).

Because the conditions under which scanner 28 generates image data may change, controller 32 may be configured to automatically cause corresponding changes to the operation of scanner 28 to accommodate the condition changes. The conditions may include, among others, the use of interior lights within cabin 22 by the operator, a time of day (e.g., dawn, midday, dusk, or night), an indication of 'weather (e.g., the use of wipers or lights by the operator), a machine travel speed, a machine location (e.g., within a tunnel), and other conditions known in the art to negatively affect scanner operation. The corresponding changes caused by controller 32 may include, among others, a lighting condition (e.g., an intensity of light produced by light sources 30) inside cabin 22, a frame rate of scanner 28, a resolution of scanner 28, an aperture size of scanner 28, an angle and position of scanner 28 or light sources 30, etc.

For example, during operation of machine 10, machine 10 may encounter overcast skies or enter a tunnel, which may reduce an amount of light entering cabin 22. If scanner 28 were to operate normally under these low-light conditions, the quality of the images produced by scanner 28 could be too low for their intended use. Accordingly, when controller 32 determines that the amount of light entering cabin 22 might be less than desired, controller 32 could selectively activate light sources 30, increase an intensity of light sources 30, change an angle or position of light sources 30, or increase an aperture size of scanner 28. Controller 32 may determine that the amount of light entering cabin 22 is less than desired based on the operator's use of input devices 24 (e.g., the use of windshield wipers, head lights, or cabin lights).

In another example, there may be times when higher than normal resolution is desired. For example, when machine 10 is traveling at high-speed, in a critical location (e.g., at a high-traffic crossing), under a critical load (e.g., a heavy and/or fragile load), over difficult terrain (e.g., around a sharp turn or over rough track), etc., it may be important to closely monitor the activities occurring inside cabin 22. Accordingly, when controller 32 determines that these conditions exist, controller 32 could selectively increase a frame rate (ex., switch from still photography to video recording, or increase the frame rate of photography and/or recording) and/or increase the resolution of scanner 28. Controller 32 may determine that these conditions exist based on the operator's use of input devices 24 (e.g., the use of a throttle lever), known speed limits, known locations, and/or and tracked positions.

In yet another example, during operation of machine 10, there may be times when continuous image capturing is unnecessary and consumes a large amount of memory space. In particular, when machine 10 is parked for an extended period of time and/or without an operator, images of an inactive or empty cabin may be less useful. Accordingly, when controller 32 determines that these conditions exist, controller 32 may cause changes to the operation of scanner 28 to accommodate the conditions. For example, controller 32 could cause a frame rate reduction of scanner 28 (e.g., controller 32 could initiate time-lapsed still photography instead of video recording), a reduction in the resolution of the images produced by scanner 28, turning off of scanner 28, etc. Controller 32 may implement these actions in response to the use of input devices 24 (e.g., in response to the setting of a park brake, the lights being turned off inside cabin 22 during night-time hours, tracked usage of a cabin door or lock, a changed throttle setting of the engines to low idle, etc.).

It may be useful to nevertheless capture some images of the inside of cabin 22, even when machine 10 is parked and the operator is assumed to be absent, for reasons of theft and/or vandalism protection. In particular, still images produced via time-lapsed photography may be helpful in apprehending any suspects, while still reducing an amount of memory space consumed by the images.

Although the disclosed cabin monitoring system may be inward focused, it is contemplated that the disclosed system could be used in conjunction with conventional outward-focused systems, if desired. For example, the cabin images and/or control over cabin image production could be correlated with environmental images and/or control over environmental image production. Specifically, changes made to externally located scanners could be similarly made to internally located scanners. Additionally or alternatively, the cabin images could be indexed (e.g., relative to time, date, machine conditions, environmental conditions, etc,) and then linked to similarly indexed images created by the outward focused systems.

It will be apparent to those skilled in the art that various modifications and variations can be made to the monitoring system of the present disclosure without departing from the scope of the disclosure. Other embodiments will be apparent to those skilled in the art from consideration of the specification and practice of the monitoring system disclosed herein. It is intended that the specification and examples be considered as exemplary only, with a true scope of the disclosure being indicated by the following claims and their equivalents.

1. A monitoring system for a mobile propulsion machine having an operator cabin, the monitoring system comprising:
at least one input device located inside the operator cabin and configured to generate a control signal that affects operation of the mobile propulsion machine;
a scanner oriented inward to capture images inside the operator cabin; and
a controller in communication with the scanner and the at least one input device, the controller being configured to:
determine a first change in conditions inside the operator cabin based on a signal from the scanner;
determine a second change in conditions inside the operator cabin based on the control signal from the at least one input device; and
selectively affect operation of the scanner based on at least one of the first change in conditions and the second change in conditions.

2. (canceled)

3. The monitoring system of claim 1, wherein the at least one input device is a windshield wiper control device.

4. The monitoring system of claim 1, wherein the at least one input device is an interior light control device.

5. The monitoring system of claim 1, wherein the at least one input device includes at least one of door control device and a door lock control device.

6. The monitoring system of claim 1, wherein the at least one input device is throttle control device.

7. The monitoring system of claim 1, wherein the scanner is a camera.

8. The monitoring system of claim 7, wherein the controller is configured to selectively affect operation of the scanner by changing at least one of a frame rate, a resolution, and an aperture size of the camera.

9. The monitoring system of claim 7, wherein:
the camera is an IR camera;
the monitoring system further includes a light source; and
the controller is configured to selectively adjust operation of the scanner by adjusting an intensity of the light source.

10. The monitoring system of claim 1, further comprising a light source, wherein the controller is configured to selectively affect operation of the scanner by changing an intensity of the light source.

11. A locomotive, comprising:
a car body;
an engine;
at least one truck configured to support the car body and the engine;
a plurality of wheels connected to the at least one truck;
an operator cabin connected to the car body and supported by the at least one truck, and having at least one operator input device located therein that is movable to create control signals that affect operation of the locomotive;
a camera oriented inward to capture images inside the operator cabin;
a light source located inside the operator cabin; and
a controller in communication with the at least one operator input device, the camera, and the light source, the controller being configured to:
determine a first change in conditions inside the operator cabin based on a signal from the camera;
determine a second change in conditions inside the operator cabin based on the control signals from the at least one operator input device; and
selectively affect at least one of a frame rate of the camera, a resolution of the camera, or an intensity of the light source based on at least one of the first change in conditions and the second change in conditions.

12. A method for monitoring an operator cabin of a mobile propulsion machine, the method comprising:
generating a control signal based on actuation of at least one operator input device that affects operation of the mobile propulsion machine;
capturing images inside the operator cabin with a scanner;
determining, via a controller, a first change in conditions inside the operator cabin based on the control signal from the at least one operator input device;
determining, via the controller, a second change in conditions inside the operator cabin based on an image signal from the scanner; and
selectively affecting operation of the scanner, via the controller, based on at least one of the first change in conditions and the second change in conditions.

13. (canceled)

14. The method of claim 12, wherein the operator input device is associated with windshield wiper control.

15. The method of claim 12, wherein the operator input device is associated with interior light control.

16. The method of claim 12, wherein the operator input device is associated with at least one of door control and door lock control.

17. The method of claim 12, wherein the operator input device is associated with throttle control.

18. The method of claim 12, wherein the scanner is a camera, and selectively affecting operation of the scanner includes selectively changing at least one of a frame rate, a resolution, and an aperture size of the camera.

19. The method of claim 18, wherein:
the camera is an IR camera; and
selectively affecting operation of the scanner includes selectively adjusting an intensity of IR light in the operator cabin.

20. The method of claim 12, wherein selectively affecting operation of the scanner includes selectively changing an amount of light inside the operator cabin.
